(19) United States
(12) Patent Application Publication
(10) Pub. No.: US 2026/0129352 A1
(43) Pub. Date: May 7, 2026

(54) EARPHONES

(71) Applicant: SHENZHEN SHOKZ CO., LTD., Shenzhen (CN)

(72) Inventors: Jianing LIANG, Shenzhen (CN); Zhen WANG, Shenzhen (CN); Chong WANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/433,943

(22) Filed: Dec. 28, 2025

Related U.S. Application Data
(63) Continuation of application No. PCT/CN2024/095602, filed on May 27, 2024.

(51) Int. Cl. H04R 1/22; H04R 1/10

(52) U.S. Cl. CPC H04R 1/22; H04R 1/1016

(57) ABSTRACT

The present disclosure relates to an earphone. The earphone includes a first speaker, a second speaker, and a driving circuit. The driving circuit is configured to drive the first speaker and the second speaker, at least a portion of a frequency band of sound output by the first speaker is lower than a frequency band of sound output by the second speaker. The earphone further includes a high-pass frequency divider disposed between the driving circuit and the second speaker and configured to perform frequency division on an audio driving signal provided by the driving circuit to the second speaker, and a frequency-dividing point of the high-pass frequency divider is set to be not lower than 6 kHz.

### CROSS-REFERENCE TO RELATED APPLICATIONS

This application is a continuation of International Patent Application No. PCT/CN2024/095602, filed on May 27, 2024, the contents of which are hereby incorporated by reference.

### TECHNICAL FIELD

The present disclosure generally relates to the field of electronic devices, and more particularly, to an earphone.

### BACKGROUND

With the development of acoustic technology, earphones have been widely used in people's daily lives. An earphone may use a combination of a plurality of speakers to output sound, so as to provide an auditory feast for a user. In the use of the earphone, different speakers may be responsible for outputting sounds of different frequency bands. Generally, a plurality of speakers that emit sounds of different frequency bands may adopt a driving manner of single-channel electrical signal driving or multi-channel electrical signal driving. When the single-channel electrical signal driving is adopted, since the diaphragm of a speaker responsible for outputting a sound of a relatively high frequency band is usually thin, the diaphragm may experience excessive amplitude when receiving a low-frequency signal, leading to distortion that compromises sound quality and user experience.

### SUMMARY

The present disclosure provides an earphone. The earphone includes a first speaker, a second speaker, and a driving circuit. The driving circuit is configured to drive the first speaker and the second speaker. At least a portion of a frequency band of sound output by the first speaker is lower than a frequency band of sound output by the second speaker. The earphone further includes a high-pass frequency divider disposed between the driving circuit and the second speaker and configured to perform frequency division on an audio driving signal provided by the driving circuit to the second speaker, and a frequency-dividing point of the high-pass frequency divider is set to be not lower than 6 KHz.

In some embodiments, the frequency-dividing point of the high-pass frequency divider is set to be not higher than 9 kHz.

In some embodiments, the frequency-dividing point of the high-pass frequency divider is set to be not lower than 8 KHz.

In some embodiments, the high-pass frequency divider is a one-order frequency divider consisting of a single capacitor.

In some embodiments, a ratio of a resonant frequency of the second speaker to the frequency-dividing point is between 0.75 and 1.25.

In some embodiments, the resonant frequency of the second speaker is equal to or greater than the frequency-dividing point.

In some embodiments, the driving circuit is configured to simultaneously drive the first speaker and the second speaker via a same digital-to-analog conversion circuit (DAC) circuit.

In some embodiments, the audio driving signal of the driving circuit is configured to be directly input to the first speaker without undergoing frequency division processing.

The present disclosure provides an earphone. The earphone includes a first speaker, a second speaker, and a driving circuit. The driving circuit is configured to drive the first speaker and the second speaker. The earphone further includes a high-pass frequency divider disposed between the driving circuit and the second speaker. A frequency-dividing point of the high-pass frequency divider is set such that a sound pressure level attenuation of sound output by the second speaker is not less than 20 dB.

In some embodiments, a ratio of a resonant frequency of the second speaker to the frequency-dividing point is between 0.75 and 1.25.

In some embodiments, the frequency-dividing point of the high-pass frequency divider is between 6 kHz and 9 kHz, and the sound pressure level attenuation of the sound output by the second speaker is not lower than 30 dB.

In some embodiments, the high-pass frequency divider performs first-order frequency division on an audio driving signal provided by the driving circuit to the second speaker.

### BRIEF DESCRIPTION OF THE DRAWINGS

In order to more clearly illustrate the technical solutions in the embodiments of the present disclosure, the drawings used in the description of the embodiments will be briefly introduced below. It is obvious that the drawings in the following description are only some embodiments of the present disclosure. For those of ordinary skill in the art, other drawings may be obtained from these drawings without creative effort.

FIG. 1 is a schematic diagram illustrating an exemplary structure of an earphone according to some embodiments of the present disclosure;

FIG. 2 is a schematic diagram illustrating an exemplary structure of the earphone in FIG. 1 from another perspective according to some embodiments of the present disclosure;

FIG. 3 is a schematic diagram illustrating an exemplary structure of the earphone in FIG. 1 from another perspective according to some embodiments of the present disclosure;

FIG. 4 is a schematic diagram illustrating an exemplary front profile of an ear of a user or a simulator according to some embodiments of the present disclosure;

FIG. 5 is a schematic diagram illustrating an exemplary earphone in FIG. 1 in a wearing state according to some embodiments of the present disclosure;

FIG. 6 is a schematic diagram illustrating an exemplary cross-sectional view taken along line VI-VI of the earphone in FIG. 1 according to some embodiments of the present disclosure;

FIG. 7 is a schematic diagram illustrating an exemplary cross-sectional view taken along line VII-VII of the earphone in FIG. 1 according to some embodiments of the present disclosure;

FIG. 8 is a schematic diagram illustrating an exemplary structure of a first housing in FIG. 6 according to some embodiments of the present disclosure;

FIG. 9 is a schematic diagram illustrating an exemplary circuit of a speaker assembly according to some embodiments of the present disclosure;

FIG. 10 is a schematic diagram illustrating an exemplary frequency division effect of a second speaker 122 under different frequency division processing conditions when adjusting a high-pass frequency divider 1304 according to some embodiments of the present disclosure;

FIG. 11 is a schematic diagram illustrating an exemplary structure of the second speaker in FIG. 7 according to other embodiments of the present disclosure; and

FIG. 12 is a schematic diagram illustrating an exemplary partial structure of a core module in FIG. 11 according to other embodiments of the present disclosure.

### DETAILED DESCRIPTION

The present disclosure is further described in detail below with reference to the accompanying drawings and embodiments. It is specifically pointed out that the following embodiments are only used to illustrate the present disclosure, but do not limit the scope of the present disclosure. Similarly, the following embodiments are only part of the embodiments of the present disclosure rather than all embodiments. All other embodiments obtained by those skilled in the art based on the embodiments of the present disclosure, without creative efforts shall fall within the protection scope of the present disclosure.

The mention of “embodiment” in the present disclosure means that a specific feature, structure, or characteristic described in connection with the embodiment may be included in at least one embodiment of the present disclosure. A person skilled in the art explicitly and implicitly understands that the embodiments described in the present disclosure may be combined with other embodiments.

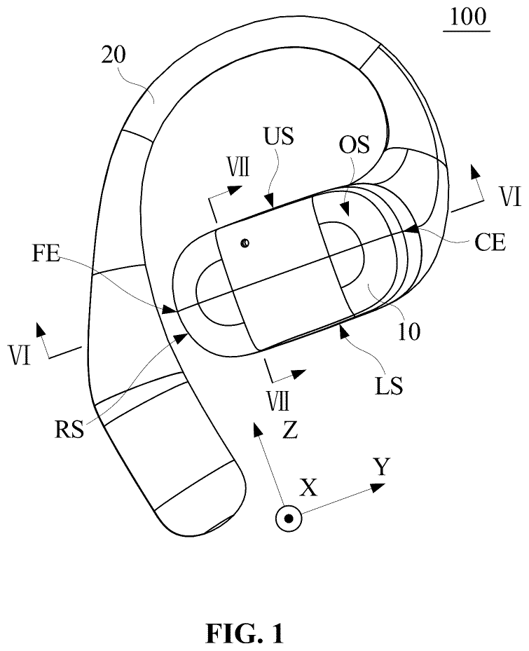

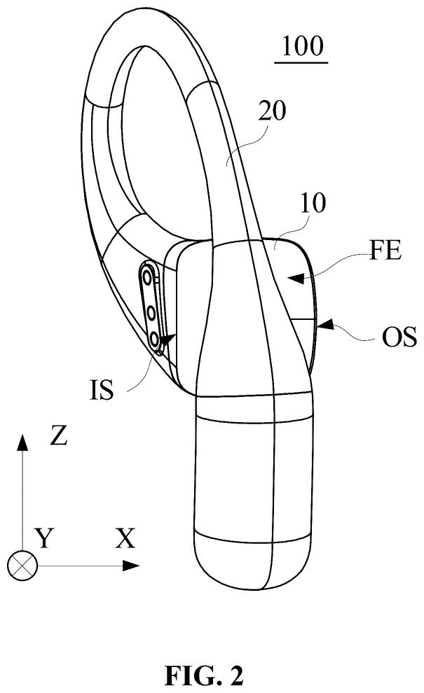

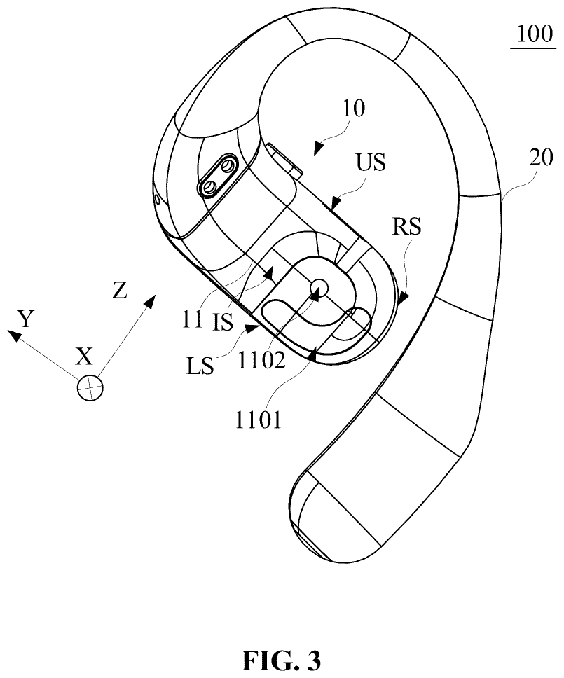

The present disclosure describes an earphone. Please refer to FIG. 1, FIG. 2, and FIG. 3, FIG. 1 is a schematic diagram illustrating an exemplary structure of the earphone according to some embodiments of the present disclosure. FIG. 2 is a schematic diagram illustrating an exemplary structure of the earphone in FIG. 1 from another perspective according to some embodiments of the present disclosure. FIG. 3 is a schematic diagram illustrating an exemplary structure of the earphone in FIG. 1 from another perspective according to some embodiments of the present disclosure. An earphone 100 may include a core module 10 and a hook structure 20 connected to the core module 10. The core module 10 may provide sound to achieve an auditory experience. In some embodiments, the core module 10 may also have other functions, such as a sound pickup function, a touch function, a press function, or a lighting function, to achieve different experiences. The core module 10 may cooperate with the hook structure 20 to achieve wearing.

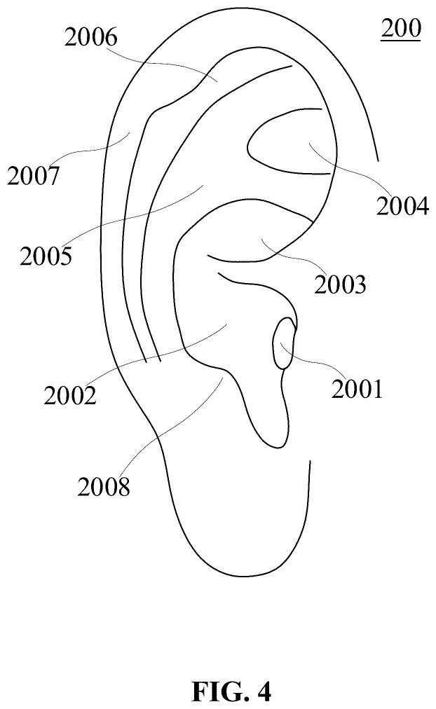

Please refer to FIG. 4, FIG. 4 is a schematic diagram illustrating an exemplary front profile of an ear of a user or a simulator according to some embodiments of the present disclosure. An ear 200 may include physiological parts such as an external auditory canal 2001, a cavum concha 2002, a cymba concha 2003, a triangular fossa 2004, an antihelix 2005, a scapha 2006, a helix 2007, and an antitragus 2008. The external auditory canal 2001 has a certain depth and may extend to the eardrum. However, for ease of description, the external auditory canal 2001 may refer to an ear hole of the ear 200 in the present disclosure unless otherwise specified. In addition, physiological parts such as the cavum concha 2002, the cymba concha 2003, and the triangular fossa 2004 may also have a certain volume and depth. The cavum concha 2002 may be directly in communication with the external auditory canal 2001. That is, the ear hole may be considered to be located at the bottom of the cavum concha 2002.

It should be understood that there may be individual differences between different users, resulting in dimensional differences in the ear 200, such as different shapes and sizes. For ease of description and to reduce (or even eliminate) the individual differences between different users, a simulator containing a head and a correspondingly ear (generally including a left ear and a right ear, one of which is taken as an example here) 200 may be made based on standards such as ANS: S3.36, S3.25, and IEC: 60318-7, for example, GRAS 45BC KEMAR, HEAD Acoustics, B&K 4128 series, or B&K 5128 series. The simulator is configured to present a scenario where most users wear the earphone 100. Taking GRAS KEMAR as an example, the simulator for the ear 200 may be any one of GRAS 45AC, GRAS 45BC, GRAS 45CC, or GRAS 43AG. Taking HEAD Acoustics as an example, the simulator for the ear 200 can be any one of HMS II.3, HMS 11.3 LN, or HMS II.3LN HEC.

It should be noted that in fields such as medicine and anatomy, three basic planes (e.g., a sagittal plane, a coronal plane, and a horizontal plane) and three basic axes (e.g., a sagittal axis, a coronal axis, and a vertical axis) may be defined for a human body or a human body simulator. The sagittal plane refers to a plane perpendicular to the ground and runs along a front-rear direction of the human body, which divides the human body or the human body simulator into a left part and a right part. The coronal plane refers to a plane perpendicular to the ground and runs along a left-right direction of the human body, which divides the human body or the human body simulator into a front part and a rear part. The horizontal plane refers to a plane parallel to the ground and runs along an up-down direction of the human body, which divides the human body or the human body simulator into an upper part and a lower part. Correspondingly, the sagittal axis is an axis along the front-rear direction of the human body and perpendicular to the coronal plane, the coronal axis is an axis along the left-right direction of the human body and perpendicular to the sagittal plane, and the vertical axis is an axis along the up-down direction of the human body and perpendicular to the horizontal plane. Furthermore, the term “front side of the ear” in the present disclosure is a concept relative to the term “rear side of the ear.” The front side of the ear refers to a side of the ear away from the head, while the rear side of the ear refers to a side of the ear facing towards the head, both being defined relative to the ear 200 of the user or the simulator. Observing the ear 200 of the human body or the human body simulator along the direction of the coronal axis yields the schematic diagram of a front contour of the ear shown in FIG. 4.

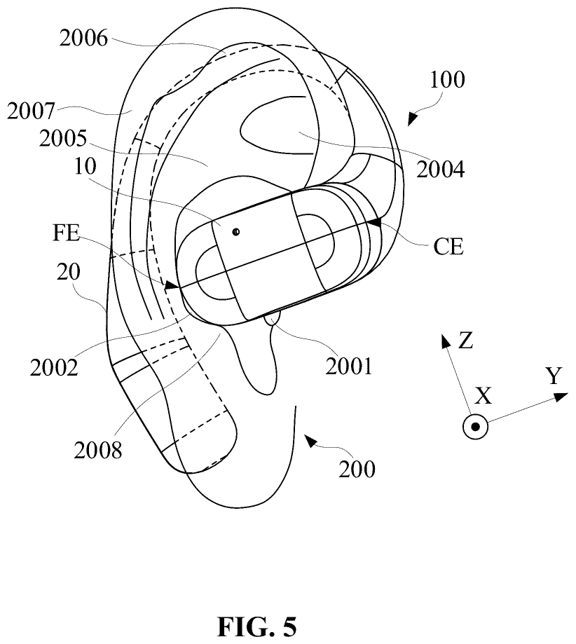

Please refer to FIG. 5, FIG. 5 is a schematic diagram illustrating an exemplary earphone 100 in FIG. 1 in a wearing state according to some embodiments of the present disclosure. The core module 10 is located on the front side of the ear 200 in the wearing state. At least a portion of the hook structure 20 is located on the rear side of the ear 200 in the wearing state, so that the earphone 100 is hung on the ear 200 in the wearing state.

In the present disclosure, descriptions such as “wearing the earphone 100,” “the earphone 100 is in the wearing state,” and “in the wearing state,” when describing the process or action of wearing the earphone 100, may all refer to the earphone 100 being worn on the ear 200. In some embodiments, precisely since different users have individual differences, there may be certain differences when the earphone 100 is worn by different users compared to when the earphone 100 is worn on the ear 200 of the simulator. However, such differences should be tolerated.

The core module 10 may be disposed to not block the external auditory canal 2001 in the wearing state, making the earphone 100 an “open earphone.” It should be understood that the core module 10 may partially cover the external auditory canal 2001 in different wearing states of the earphone 100, but the external auditory canal 2001 remains unblocked.

Please refer to FIG. 1, FIG. 2, and FIG. 3, the core module 10 may have a connection end CE connected to the hook structure 20 and a free end FE not connected to the hook structure 20. In the wearing state, the free end FE of the core module 10 may extend into the cavum concha 2002, or may only cover at least a portion of the cavum concha 2002. The core module 10 and the hook structure 20 may be disposed to clamp the ear 200 from the front and rear sides of the region of the ear 200 corresponding to the cavum concha 2002. This increases the resistance of the earphone 100 to falling off from the ear 200, thereby improving the stability of the earphone 100 in the wearing state.

The core module 10 may have a thickness direction X, a length direction Y perpendicular to the thickness direction X, and a width direction Z perpendicular to both the thickness direction X and the length direction Y. In some embodiments, the length direction Y may be defined as a direction in which the core module 10 faces toward or away from the back of the head in the wearing state. The width direction Z may be defined as a direction in which the core module 10 faces toward or away from the top of the head in the wearing state. The thickness direction X may be defined as a direction in which the core module 10 faces toward or away from the user's ear in the wearing state. In some embodiments, the length direction Y may be defined as a direction from the connection end of the core module 10 to the free end of the core module 10, and the thickness direction X may be defined as a direction in which the core module 10 faces toward or away from the user's ear in the wearing state. In some embodiments, the free end FE is pressed against the inside of the cavum concha 2002 along the thickness direction X. As another example, the free end FE abuts against the inside of the cavum concha 2002 along the length direction Y and the width direction Z.

It should be noted that in the wearing state, the free end FE of the core module 10 can not only be set to extend into the cavum concha 2002, but can also be set to have its orthographic projection fall on the antihelix 2005, or to have its orthographic projection fall on the left side or right side of the head at a position located at the front side of the ear 200 along the sagittal axis.

In some embodiments, in other scenarios, at least a portion of the core module 10 may also have an orthographic projection falling on the antihelix 2005. Alternatively, at least a portion of the core module 10 may have an orthographic projection falling on the left side or right side of the head at a position located at the front side of the ear 200 along the sagittal axis.

In other words, the hook structure 20 may support the core module 10 to be worn in wearing positions such as the cavum concha 2002, the antihelix 2005, or the front side of the ear 200.

Please refer to FIG. 1, FIG. 2, and FIG. 5, in the wearing state, when observed along the direction of the coronal axis, the core module 10 may be configured to have a shape such as a circle, an ellipse, a rounded square, or a rounded rectangle. Therefore, for ease of description, this embodiment uses an example where the core module 10 is configured as a rounded rectangle for illustrative purposes. In some embodiments, a length of the core module 10 in the length direction Y may be greater than a width of the core module 10 in the width direction Z.

The core module 10 may have an inner side surface IS facing the ear 200 along the thickness direction X in the wearing state, an outer side surface OS facing away from the ear 200 along the thickness direction X in the wearing state, and a connection surface connecting the inner side surface IS and the outer side surface OS (e.g., a lower side surface LS, an upper side surface US, and a rear side surface RS). In the wearing state of the core module 10, the upper side surface US connects the inner side surface IS and the outer side surface OS, and the lower side surface LS connects the inner side surface IS and the outer side surface OS. The upper side surface US is closer to the top of the user's head along the width direction Z. The lower side surface LS is farther from the top of the user's head along the width direction Z. The rear side surface RS connects the upper side surface US and the lower side surface LS, and may also connect the inner side surface IS and the outer side surface OS. The thickness direction X may also be defined as a direction in which the core module 10 faces toward or away from the ear 200 in the wearing state. At least a portion of the connection surface, such as the rear side surface RS, is located within the cavum concha 2002 in the wearing state and forms a first contact region with the front side of the region of the ear 200. That is, the rear side surface RS may be located at an end in the length direction Y toward the back of the head in the wearing state, and at least partially located in the cavum concha 2002. In some embodiments, the hook structure 20 forms a second contact region with the rear side of the region of the ear 200 in the wearing state. The second contact region and the first contact region at least partially overlap in an ear thickness direction of the region of the ear 200, thus the core module 10 and the hook structure 20 can jointly clamp the ear 200 from the front and rear sides of the ear 200. The formed clamping force is mainly compressive stress, which is beneficial for improving the stability and comfort of the earphone 100 in the wearing state. In some embodiments, when the core module 10 is configured as a circular shape, an elliptical shape, or other shapes, the connection surface may also refer to an arc-shaped side surface of the core module 10.

It should be noted that the terms “first,” “second,” “third,” etc., in the present disclosure are used for descriptive purposes only and cannot be understood as indicating or implying relative importance or implicitly specifying the quantity of the indicated technical features. Thus, features defined by terms such as “first,” “second,” and “third” may explicitly or implicitly include at least one such feature. In the description of the present disclosure, the meaning of “a plurality of” is at least two, e.g., two and three, unless explicitly and specifically defined otherwise.

It should be understood that the core module 10 may also be worn directly or through other means, or may even be connected and cooperate with other structures in coordination with the hook structure 20 to achieve wearing. Thus, the implementation of the functions of the core module 10 is not limited to the embodiments listed in the present disclosure. In some embodiments, the hook structure 20 may be omitted or replaced with other structures.

Additionally, when the wearing manner of the core module 10 changes, the cooperation manner between the core module 10 and the ear 200 may also change. However, in some embodiments, this does not necessarily cause changes to the internal structure, overall construction, external structure, etc., of the core module 10. Even in some embodiments, terms involving orientation, such as the lower side surface LS, the upper side surface US, and the rear side surface RS, may not necessarily correspond to the ear 200. Certainly, in some embodiments, terms such as the connection end CE may merely become terms involving orientation, and do not necessarily imply the inclusion of a specific function.

Furthermore, when the wearing manner of the core module 10 changes, the core module 10 may not cooperate with the hook structure 20 or other structures at the connection end CE to achieve wearing.

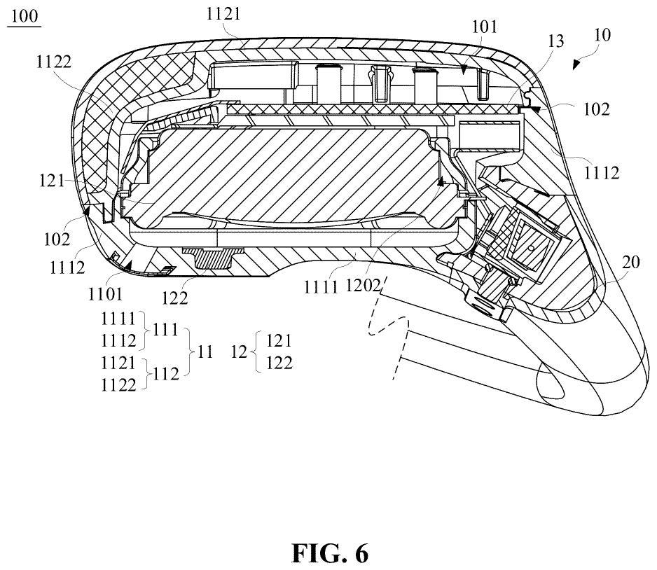

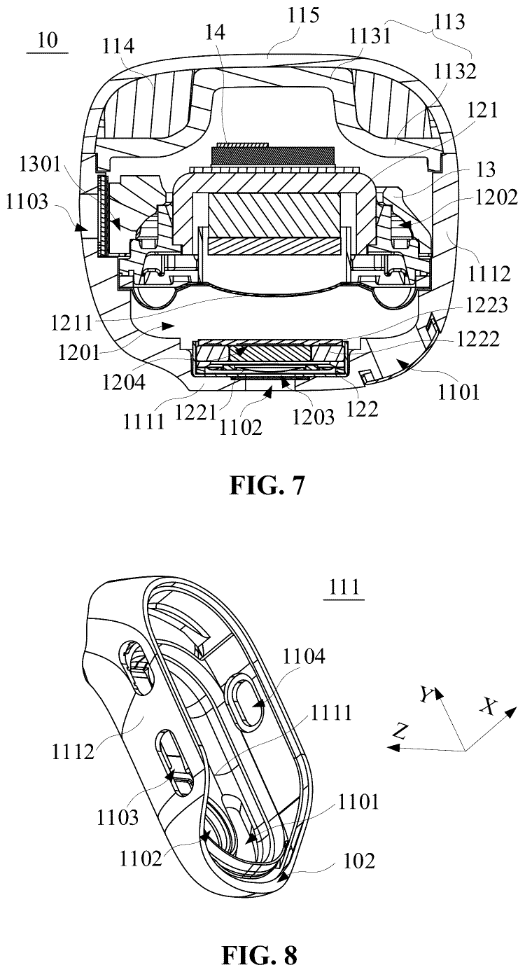

Please refer to FIG. 6 and FIG. 7, FIG. 6 is a schematic diagram illustrating an exemplary cross-sectional view taken along line VI-VI of the earphone 100 in FIG. 1 according to some embodiments of the present disclosure. FIG. 7 is a schematic diagram illustrating an exemplary cross-sectional view taken along line VII-VII of the earphone 100 in FIG. 1 according to some embodiments of the present disclosure. The core module 10 includes a core housing 11, a speaker assembly 12, and a main control circuit board 13. The core housing 11 may be connected to the hook structure 20. The core housing 11 may have a mounting space 101 for mounting the speaker assembly 12 and the main control circuit board 13. Other electronic components may also be mounted therein, which will not be described in detail here. The speaker assembly 12 and the main control circuit board 13 may be disposed in the core housing 11, for example, in the mounting space 101. The main control circuit board 13 may be electrically connected to the speaker assembly 12 and is configured to control the operation of the speaker assembly 12. It should be understood that the core housing 11 serves as an external housing of the core module 10. Therefore, the inner side surface IS, the outer side surface OS, and the connection surfaces (e.g., the lower side surface LS, the upper side surface US, and the rear side surface RS) connecting the inner side surface IS and the outer side surface OS of the core module 10 are all formed on the core housing 11, serving as outer surfaces of the core housing 11. The aforementioned length direction Y may be defined as a direction in which the core housing 11 faces toward or away from the back of the head in the wearing state, the width direction Z may be defined as a direction in which the core housing 11 faces toward or away from the top of the head in the wearing state, and the thickness direction X may be defined as a direction in which the core housing 11 faces toward or away from the user's ear in the wearing state. In some embodiments, the length direction Y may be defined as a direction from the connection end of the core housing 11 to the free end of the core module 10, and the thickness direction X may be defined as a direction in which the core housing 11 faces toward or away from the user's ear in the wearing state.

The core housing 11 may include a first housing 111 and a second housing 112 that are engaged with each other along the thickness direction X to form the mounting space 101. The first housing 111 is closer to the ear 200 than the second housing 112 in the wearing state. A parting surface 102 is provided between the first housing 111 and the second housing 112 to simplify the structure of the core housing 11 and reduce processing costs. Certainly, the core housing 11 may also have other structural forms and is not limited to the embodiments listed in the present disclosure.

In some embodiments, a first sound outlet hole 1101 and a second sound outlet hole 1102 communicating with the mounting space 101 may be provided on the core housing 11. The first sound outlet hole 1101 and the second sound outlet hole 1102 may cooperate with the speaker assembly 12, respectively, so that sound waves generated by the speaker assembly 12 may be transmitted through the first sound outlet hole 1101 and the second sound outlet hole 1102, respectively. The first sound outlet hole 1101 and the second sound outlet hole 1102 may not communicate with each other. Providing two sound outlet holes can improve the auditory experience of the speaker assembly 12 and avoid sound wave interference between a plurality of speakers.

Please refer to FIG. 8, FIG. 8 is a schematic diagram illustrating an exemplary structure of the first housing 111 in FIG. 6 according to some embodiments of the present disclosure. In some embodiments, the first sound outlet hole 1101 and/or the second sound outlet hole 1102 may be provided on the first housing 111. For example, both the first sound outlet hole 1101 and the second sound outlet hole 1102 may be provided on a bottom wall 1111 of the first housing 111. In some embodiments, the bottom wall 1111 may be provided corresponding to the inner side surface IS of the core module 10. When the wearing manner that the core module 10 extending into the cavum concha 2002 is adopted, since the cavum concha 2002 has a certain volume and depth, after the free end FE extends into the cavum concha 2002, a portion of the inner side surface IS corresponding to the bottom wall 1111 of the core housing 11 may have a certain distance from the cavum concha 2002. Thus, the core housing 11 and the cavum concha 2002 may cooperate to form an auxiliary cavity communicating with the external auditory canal 2001 in the wearing state. The first sound outlet hole 1101 and the second sound outlet hole 1102 are at least partially located within the auxiliary cavity. As a result, in the wearing state, the sound waves generated by the speaker assembly 12 and propagating out through the first sound outlet hole 1101 and the second sound outlet hole 1102 are confined by the auxiliary cavity. That is, the auxiliary cavity may concentrate the sound waves, allowing more sound waves to be transmitted into the external auditory canal 2001, thereby increasing the volume and improving the sound quality heard by the user in the near field. This is beneficial for improving the acoustic effect of the earphone 100.

In some embodiments, both the first sound outlet hole 1101 and the second sound outlet hole 1102 are closer to the free end FE than to the connection end CE, so that the first sound outlet hole 1101 and the second sound outlet hole 1102 are closer to the external auditory canal 2001 in the wearing state. In some embodiments, since the core module 10 may be configured not to block the external auditory canal 2001 in the wearing state, the auxiliary cavity may be configured as semi-open.

In some embodiments, the first housing 111 includes a first side wall 1112 extending from an edge of the bottom wall 1111 toward a side closer to the second housing 112. The first sound outlet hole 1101 and/or the second sound outlet hole 1102 may not be provided on the bottom wall 1111, but may be provided on a side of the first side wall 1112 corresponding to the lower side surface LS, or at a corner between the first side wall 1112 and the bottom wall 1111, or even at other parts of the core housing 11, e.g., the inner side surface IS, the lower side surface LS, or a corner between the inner side surface IS and the lower side surface LS.

Please refer to FIG. 7 and FIG. 8, the first housing 111 may be a plastic component, or a structure composed of or compounded from multiple materials. Alternatively, the first housing 111 may also be a housing structure made of other materials. In some embodiments, a pressure relief hole 1103 and/or a tuning hole 1104 may be provided on the first side wall 1112. That is, the pressure relief hole 1103 and/or the tuning hole 1104 may be provided on the upper side surface US or the lower side surface LS of the core housing 11. Furthermore, an acoustic resistance mesh, a protective steel mesh, etc., may be provided at the pressure relief hole 1103 and/or the tuning hole 1104.

It should be understood that acoustic holes such as the pressure relief hole 1103 and the tuning hole 1104 may be adjusted according to the needs of those skilled in the art and provided on the core housing 11, e.g., on the first housing 111. For example, the pressure relief hole 1103 and the tuning hole 1104 may be provided at positions on the first housing 111 that cooperate with the speaker assembly 12, and are not limited to the positions listed here. As another example, the pressure relief hole 1103 and the tuning hole 1104 may be provided at positions on the first side wall 1112 that cooperate with the speaker assembly 12, and are not limited to the positions listed here. As still another example, the pressure relief hole 1103 and the tuning hole 1104 may be provided on opposite sides of the first side wall 1112 along the width direction Z, respectively.

Additionally, since the first sound outlet hole 1101, the pressure relief hole 1103, and the tuning hole 1104 may all be provided on the first housing 111, the structure of the first housing 111 is simpler, which is beneficial for reducing processing costs. Furthermore, since the pressure relief hole 1103 and the tuning hole 1104 are provided on opposite sides of the first side wall 1112 along the width direction Z, respectively, the aforementioned parting surface 102 may be symmetrically arranged about a reference plane perpendicular to the width direction Z. This is beneficial for improving the appearance quality of the core module 10.

Moreover, the acoustic holes are not limited to the pressure relief hole 1103 and the tuning hole 1104, and may also include other acoustic holes cooperating with the speaker assembly 12. In some embodiments, at least one of the pressure relief holes 1103 and the tuning hole 1104 may be omitted.

Referring to FIG. 6, the second housing 112 may be a plastic component or a structure composed of or compounded from multiple materials. In some embodiments, the second housing 112 may also be a housing structure made of other materials. The parting surface 102 between the second housing 112 and the first housing 111 (e.g., the first side wall 1112) extends or bends toward a side where the first housing 111 is located in a direction approaching the free end FE. The second housing 112 may include a top wall 1121 disposed opposite to the first housing 111 (e.g., the bottom wall 1111) and a second side wall 1122 connected to the top wall 1121 and engaged with the first housing 111 (e.g., the first side wall 1112).

It should be understood that, due to the configuration of the second side wall 1122, the free end FE is tapered in a direction away from the connection end CE, which facilitates cooperation with the contour of a user's ear and improves the wearing experience.

Referring to FIG. 6 and FIG. 7, the speaker assembly 12 may generate the sound waves after being powered on. The sound waves may be transmitted through the first sound outlet hole 1101 and/or the second sound outlet hole 1102 to facilitate entry into the external auditory canal 2001. The speaker assembly 12 may be coupled to the main control circuit board 13 to allow operation under the control of the main control circuit board 13. The speaker assembly 12 may include a first speaker 121 and a second speaker 122 disposed within the core housing 11 (e.g., within the mounting space 101). The first speaker 121 and the second speaker 122 may be coupled to the main control circuit board 13, respectively, to allow the operation under the control of the main control circuit board 13. The sound waves generated by the first speaker 121 may be transmitted through the first sound outlet hole 1101. The sound waves generated by the second speaker 122 may be transmitted through the second sound outlet hole 1102. In some embodiments, the sound waves generated by the first speaker 121 may also be transmitted through acoustic holes such as the pressure relief hole 1103 and the tuning hole 1104. In some embodiments, it is also possible for only one of the pressure relief holes 1103 or the tuning hole 1104 to cooperate with the first speaker 121 to transmit the sound waves.

Referring to FIG. 6 and FIG. 7, the first speaker 121 may be fixed within the core housing 11. An axial direction of the first speaker 121 may be arranged along the thickness direction X. In some embodiments, the first speaker 121 may be fixed on the first housing 111 (e.g., the bottom wall 1111). In some embodiments, the first speaker 121 may also be fixed on the first side wall 1112 or other parts of the core housing 11.

In some embodiments, the first speaker 121 may have a strip-like structure to match the core housing 11 (e.g., the mounting space 101). That is, the first speaker 121 may extend in a direction from the connection end CE to the free end FE. This facilitates the arrangement of a sufficiently large first speaker 121 within the core housing 11 (e.g., the mounting space 101), thereby enhancing the sound volume produced by the earphone 100, optimizing the layout, and improving space utilization.

Referring to FIG. 7, the first speaker 121 may include a first diaphragm 1211 for vibrating to produce sound, a first magnetic circuit system for driving the first diaphragm 1211 to vibrate and generate sound, and a support member for carrying the first diaphragm 1211 and the first magnetic circuit system. The technical principle of the first magnetic circuit system driving the first diaphragm 1211 to vibrate and generate sound is within the understanding of those skilled in the art and will not be elaborated here.

The first speaker 121 cooperates with the core housing 11 within the core housing 11 (e.g., within the mounting space 101) to form a first front cavity 1201 on a front side of the first diaphragm 1211 of the first speaker 121 and a first rear cavity 1202 on a rear side of the first diaphragm 1211. The front side of the first diaphragm 1211 refers to a side of the first diaphragm 1211 facing away from the first magnetic circuit system. The rear side of the first diaphragm 1211 refers to a side of the first diaphragm 1211 facing toward the first magnetic circuit system. In some embodiments, the first front cavity 1201 is located on a side of the first speaker 121 facing toward the inner side surface IS of the core housing 11 (e.g., facing toward the bottom wall 1111 of the first housing 111). The first rear cavity 1202 is located on a side of the first speaker 121 facing away from the inner side surface IS (e.g., facing away from the bottom wall 1111 of the first housing 111). In some embodiments, the first front cavity 1201 may communicate with the first sound outlet hole 1101, allowing the sound waves generated by the first speaker 121 to be transmitted through the first sound outlet hole 1101.

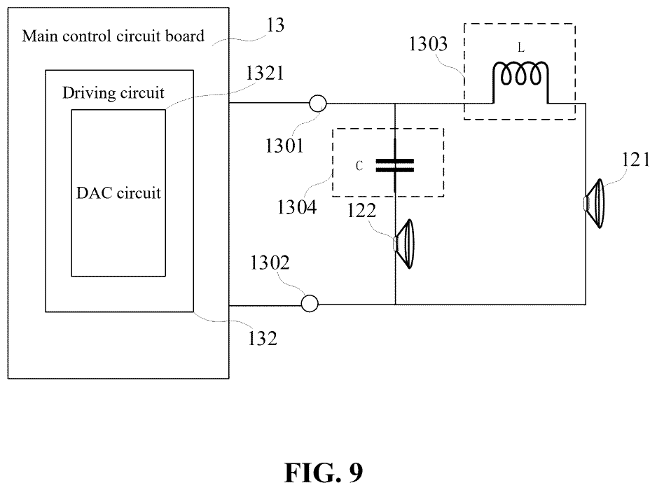

Referring to FIG. 9, FIG. 9 is a schematic diagram illustrating an exemplary circuit of a speaker assembly 12 in some embodiments of the present disclosure. The speaker assembly 12 may have a first connection terminal 1301 and a second connection terminal 1302, respectively, electrically connected to the main control circuit board 13. The first speaker 121 may be connected in series between the first connection terminal 1301 and the second connection terminal 1302, thereby generating sound under the control of the main control circuit board 13. In some embodiments, the speaker assembly 12 may further include a low-pass frequency divider 1303 connected in series with the first speaker 121 and is between the first connection terminal 1301 and the second connection terminal 1302, so as to achieve the low-pass filtering via the low-pass frequency divider 1303, causing the first speaker 121 to receive only electrical signals of a lower frequency band. The low-pass frequency divider 1303 performs the frequency division processing on an audio driving signal to generate an electrical signal input to the first speaker 121. Certainly, when the low-pass frequency divider 1303 does not perform the frequency division processing on the audio driving signal, the audio driving signal is the electrical signal input to the first speaker 121, thus, the first speaker 121 outputs more sound in the lower frequency band. In some embodiments, the audio driving signal is provided by the main control circuit board 13. The low-pass frequency divider 1303 may perform a first-order frequency division on the audio driving signal provided by the main control circuit board 13 to the first speaker 121 to reduce the circuit complexity. In some embodiments, the low-pass frequency divider 1303 may include a frequency division inductor L. A count of the frequency division inductors L may be at least one. In this case, the low-pass frequency divider 1303 may perform the frequency division processing on the audio driving signal provided by the main control circuit board 13 to the first speaker 121.

In the present disclosure, the low-pass frequency divider 1303 may be a first-order frequency divider or a multi-order frequency divider. In some embodiments of the present disclosure, the low-pass frequency divider 1303 is a first-order frequency divider. That is, the low-pass frequency divider 1303 includes one frequency division inductor L. Thus, the design of the low-pass frequency divider 1303 is simpler and the cost is lower. Furthermore, when selecting the count of the frequency division inductors L, since the low-pass frequency divider 1303 requires fewer frequency division inductors L for the first-order frequency division, thereby reducing the occupation of the core housing 11 (e.g., the mounting space 101). This results in a more compact core module 10, and when cooperating with the main control circuit board 13, lowers the requirements for the main control circuit board 13, making the main control circuit board 13 smaller.

In some embodiments, the audio driving signal provided by the main control circuit board 13 may be directly transmitted to the first speaker 121. That is, the audio driving signal may be directly input to the first speaker 121 without undergoing the frequency division processing. In some embodiments, a frequency range of the audio driving signal may be the same as an operating frequency range of the first speaker 121.

In some embodiments, the main control circuit board 13 includes a driving circuit 132. The driving circuit 132 is connected to the first speaker 121 and the second speaker 122 to drive the first speaker 121 and the second speaker 122 to work. In some embodiments, the driving circuit 132 may include one digital-to-analog conversion (DAC) circuit 1321. The first speaker 121 and the second speaker 122 are connected to the DAC circuit 1321. The one DAC circuit 1321 is configured to simultaneously drive the first speaker 121 and the second speaker 122. That is, the driving circuit 132 may simultaneously input the same audio driving signal to the first speaker 121 and the second speaker 122 to drive the first speaker 121 and the second speaker 122 to work.

The second speaker 122 is disposed within the mounting space 101 of the core housing 11. Referring to FIG. 6 and FIG. 7, the second speaker 122 may be fixed on the first housing 111 (e.g., the bottom wall 1111). In this case, the axial direction of the second speaker 122 may be along the thickness direction X. In some embodiments, the second speaker 122 may be located within the first front cavity 1201 of the first speaker 121, and in this case, the axial direction of the first speaker 121 and the axial direction of the second speaker 122 are parallel. In other embodiments, the second speaker 122 may also be fixed on the first side wall 1112 or other parts of the core housing 11. The axial direction of the second speaker 122 may also be arranged to cross the thickness direction X.

In some embodiments, the second speaker 122 may be embedded in an inner wall of the core housing 11. For example, a groove may be formed on the inner wall of the core housing 11 to accommodate the second speaker 122, thereby achieving an embedded configuration of the second speaker 122. Referring to FIG. 7, the groove for accommodating the second speaker 122 may be formed on the bottom wall 1111 of the first housing 111. In this case, in the wearing state, the second speaker 122 is located on the inner wall of the core module 10 corresponding to the inner side surface IS, and the second speaker 122 is closer to the user's ear. As another example, the groove for accommodating the second speaker 122 may be formed on an inner wall of one of the lower side surface or various connection surfaces of the core module 10 to adapt to different wearing scenarios, thereby providing a better auditory experience for the user.

Referring to FIG. 7, the second speaker 122 may include a second diaphragm 1221 for vibrating to generate sound, a second magnetic circuit system 1222 for driving the second diaphragm 1221 to generate sound, and a speaker housing 1223 for carrying and mounting the second diaphragm 1221 and the second magnetic circuit system 1222. The technical principle of the second magnetic circuit system 1222 driving the second diaphragm 1221 to vibrate and generate sound is within the understanding of those skilled in the art and will not be elaborated here.

The second speaker 122 cooperates with the core housing 11 within the core housing 11 (e.g., within the mounting space 101). A second front cavity 1203 is formed by cooperation between the front side of the second diaphragm 1221 of the second speaker 122 and the core housing 11. A second rear cavity 1204 is formed by cooperation between the rear side of the second diaphragm 1221 and the speaker housing 1223. The front side of the second diaphragm 1221 refers to a side of the second diaphragm 1221 facing away from the second magnetic circuit system 1222. The rear side of the second diaphragm 1221 refers to a side of the second diaphragm 1221 facing toward the second magnetic circuit system 1222. When the second speaker 122 is located on the inner wall of the core module 10 corresponding to the inner side surface IS, the second front cavity 1203 is located on a side of the second speaker 122 facing toward the inner side surface IS, and the second rear cavity 1204 is located on a side of the second speaker 122 facing away from the inner side surface IS.

The second front cavity 1203 may communicate with the second sound outlet hole 1102, allowing the sound waves generated by the second speaker 122 to be transmitted from the second sound outlet hole 1102. In some embodiments, the core housing 11 may include a structure such as an isolation plate disposed between the second speaker 122 and the first speaker 121 to isolate a cavity coupled by the core housing 11 with the first speaker 121 and a cavity coupled by the core housing 11 with the second speaker 122. This ensures that the first sound outlet hole 1101 communicates only with the first front cavity 1201, and the second sound outlet hole 1102 communicates only with the second front cavity 1203. In some embodiments, the second speaker 122 may be located farther from the connection end CE than the free end FE to cooperate with the second sound outlet hole 1102.

In some embodiments, the speaker housing 1223 is a housing structure distinct from the core housing 11, to allow flexible installation of the second speaker 122 on the core module 10. In some embodiments, the speaker housing 1223 includes a support member that carries the second diaphragm 1221 and the second magnetic circuit system 1222, and a cover connected to the core housing 11 to fix the second speaker 122. The cover is provided with a sound hole that communicates with the second sound outlet hole 1102. In some embodiments, the speaker housing 1223 includes only a support member that carries the second diaphragm 1221 and the second magnetic circuit system 1222, and is connected to the core housing 11 via the support member to fix the second speaker 122.

A frequency range of sound output by the first speaker 121 is at least partially lower than a frequency range of sound output by the second speaker 122. In some embodiments, the frequency range of sound output by the first speaker 121 may be entirely less than the frequency range of sound output by the second speaker 122. In some other embodiments, the frequency range of sound output by the first speaker 121 partially overlaps the frequency range of sound output by the second speaker 122, and a maximum frequency of sound output by the first speaker is lower than a maximum frequency of sound output by the second speaker, such that a frequency band of sound output by the second speaker 122 may be partially greater than a frequency band of sound output by the first speaker 121.

In some embodiments, the frequency range of sound output by the first speaker 121 may include 20 Hz to 5 kHz, and the frequency range of sound output by the second speaker 122 may include 5 kHz to 20 KHz. In some embodiments, the frequency range of sound output by the first speaker 121 and the frequency range of sound output by the second speaker 122 may have different standards based on actual situations. For example, the frequency range of sound output by the first speaker 121 may also refer to a frequency range not higher than 1 kHz, e.g., 1 Hz to 1 kHz, 100 Hz to 800 Hz, etc.

In some embodiments, the frequency range of sound output by the first speaker 121 may be a low-frequency band or a mid-low-frequency band, and the frequency range of sound output by the second speaker 122 may be a high-frequency band or a mid-high-frequency band. Accordingly, the first speaker 121 may be referred to as a low-frequency speaker, and the second speaker 122 may be referred to as a high-frequency speaker. The low-frequency band may be at least a portion of a frequency band substantially from 20 Hz to 500 Hz, or at least a portion of a frequency band substantially from 20 Hz to 3 kHz. The high-frequency band may be at least a portion of a frequency band substantially from 5 kHz to 20 KHz, or at least a portion of a frequency band from 6 KHz to 16 KHz. A mid-frequency band may be between the low-frequency band and the high-frequency band, or may partially overlap the low-frequency band and/or the high-frequency band. Accordingly, the mid-low-frequency band may be a combination of the low-frequency band and the mid-frequency band, and the mid-high-frequency band may be a combination of the mid-frequency band and the high-frequency band.

It should be understood that the above division of frequency bands is merely given as an example to roughly indicate intervals. The definition of the above frequency bands may change according to different industries, different application scenarios, and different classification standards. For example, in other application scenarios, the low-frequency band refers to a frequency band substantially from 20 Hz to 80 Hz, the mid-low-frequency band may refer to a frequency band substantially between 80 Hz and 160 Hz, the mid-frequency band may refer to a frequency band substantially from 160 Hz to 1280 Hz, the mid-high-frequency band may refer to a frequency band substantially from 1280 Hz to 2560 Hz, and the high-frequency band may refer to a frequency band substantially from 2560 Hz to 120 KHz.

In some embodiments, the main control circuit board 13 may provide identical audio driving signals to the first speaker 121 and the second speaker 122. In other words, the frequencies of electrical signals received by the first speaker 121 and the second speaker 122 may be the same. In this case, the second diaphragm 1221 of the second speaker 122 may vibrate under an electrical signal in a frequency band not higher than 200 Hz. When the first speaker 121 is the aforementioned low-frequency speaker and the second speaker 122 is the aforementioned high-frequency speaker, the frequency range of sound output by the first speaker 121 is at least partially lower than the frequency range of sound output by the second speaker 122. That is, the sound output effect of the first speaker 121 is better in a relatively low frequency band, and the sound output effect of the second speaker 122 is better in a relatively high frequency band.

In some embodiments, on a reference plane perpendicular to the axial direction of the first speaker 121, an orthographic projection of the second speaker 122 on the reference plane at least partially overlaps an orthographic projection of the first speaker 121 on the reference plane. In some embodiments, on the reference plane perpendicular to the axial direction of the first speaker 121, the orthographic projection of the second speaker 122 on the reference plane entirely overlaps the orthographic projection of the first speaker 121 on the reference plane, optimizing the arrangement and improving space utilization. In some embodiments, the axial direction of the first speaker 121 may be a vibration direction of the first diaphragm 1211. In some embodiments, the axial direction of the second speaker 122 may point toward the first speaker 121. In some embodiments, the axial direction of the second speaker 122 may be parallel to the axial direction of the first speaker 121, i.e., an angle between the axial direction of the second speaker 122 and the axial direction of the first speaker 121 may be 0 degrees.

It should be understood that a positional relationship and a cooperation relationship between the second speaker 122 and the first speaker 121, and their respective positional relationships and cooperation relationships with the core housing 11, may also be adjusted and changed, and are not limited to the embodiments listed herein.

Please refer to FIG. 7. The main control circuit board 13 may provide the audio driving signal to the second speaker 122, such that the second diaphragm 1221 of the second speaker 122 can vibrate under an electrical signal in a frequency band not higher than 200 Hz. When the second speaker 122 is the aforementioned high-frequency speaker, the sound output effect of the second speaker 122 is better in a relatively high frequency band, but its performance is poorer in a relatively low frequency band. This may cause the second diaphragm 1221 of the second speaker 122 to exhibit distortion when vibrating under an electrical signal in a frequency band not higher than 200 Hz.

Referring to FIG. 9, the second speaker 122 may be connected in series between the first connection terminal 1301 and the second connection terminal 1302, and thus may generate sound under the control of the main control circuit board 13. In some embodiments, the speaker assembly 12 may further include a high-pass frequency divider 1304 connected in series with the second speaker 122 and is between the first connection terminal 1301 and the second connection terminal 1302, to achieve high-pass filtering through the high-pass frequency divider 1304. In some embodiments, the first connection terminal 1301 and the second connection terminal 1302 cooperate to receive the audio driving signal from the main control circuit board 13, and may enable the high-pass frequency divider 1304 to perform frequency division on the audio driving signal to generate an electrical signal received by the second speaker 122. This may cause the electrical signal received by the second speaker 122 to achieve attenuation in a frequency band below a frequency-dividing point, and simultaneously cause a sound pressure level attenuation of the sound output by the second speaker 122 in the low-frequency band, thereby alleviating the sound distortion phenomenon existing when the second speaker 122 outputs sound in a relatively low frequency band (e.g., below 200 Hz, such as 50-100 Hz).

In some embodiments, the frequency-dividing point at which the high-pass frequency divider 1304 performs frequency division on the audio driving signal may be not lower than 6 kHz, so that the sound pressure level of the sound output by the second speaker 122 may achieve attenuation at least below 6 kHz, and the second speaker 122 may achieve good acoustic output effect in frequency bands above 6 kHz. In some embodiments, the frequency-dividing point at which the high-pass frequency divider 1304 performs frequency division on the audio driving signal may be set to be not lower than 8 kHz. In some embodiments, the frequency-dividing point may be 8 kHz. Since the sound output effect of the first speaker 121 is poorer in higher frequency bands, the second speaker 122 may compensate for the sound pressure level of the output sound in frequency bands above 8 kHz. In some embodiments, the frequency-dividing point at which the high-pass frequency divider 1304 performs frequency division on the audio driving signal may be set to be not higher than 9 kHz, to avoid affecting the sound output by the second speaker 122 in the higher frequency bands, thereby ensuring the sound output capability of the earphone across the full frequency range.

In some embodiments, the setting of the frequency-dividing point may cause the sound pressure level attenuation of the sound output by the second speaker 122 in the low-frequency bands (e.g., below 200 Hz, such as 50-100 Hz) to be not less than 20 dB, to alleviate the sound distortion phenomenon occurring when the output of the second speaker 122 is in lower frequency bands. In some embodiments, the setting of the frequency-dividing point may cause the sound pressure level attenuation of the sound output by the second speaker 122 in the low-frequency bands (e.g., below 200 Hz, such as 50-100 Hz) to be not less than 30 dB, to alleviate the sound distortion phenomenon occurring when the output of the second speaker 122 is in lower frequency bands.

In some embodiments, the frequency-dividing point may be set near a resonant frequency of the second speaker 122, which may cause the electrical signal received by the second speaker 122 below the frequency-dividing point to be attenuated, thereby improving the sound distortion phenomenon existing when the output of the second speaker 122 is in low-frequency bands (e.g., below 200 Hz). In some embodiments, a ratio of the resonant frequency of the second speaker 122 to the frequency-dividing point is between 0.75 and 1.25. In some embodiments, the ratio of the resonant frequency of the second speaker 122 to the frequency-dividing point is between 0.9 and 1.1.

In some embodiments, the resonant frequency of the second speaker 122 may not be lower than 6 kHz, and the second diaphragm 1221 may vibrate under an electrical signal at least in a frequency band from 1 kHz to 20 KHz. In some embodiments, the resonant frequency of the second speaker 122 may be between 6 kHz and 9 KHz.

In some embodiments, the aforementioned high-pass frequency divider 1304 may be configured to perform first-order frequency division on the audio driving signal from the main control circuit board 13, to reduce circuit complexity while improving the sound distortion phenomenon existing in the output of the second speaker 122 in low-frequency bands. In this case, the high-pass frequency divider 1304 may include a frequency-dividing capacitor C, and a count of the frequency-dividing capacitors C is one. Such a configuration reduces the occupation of the core housing 11 (e.g., the mounting space 101). This results in a more compact core module 10, and when cooperating with the main control circuit board 13, lowers the requirements for the main control circuit board 13, making the main control circuit board 13 smaller. It should be understood that, in other embodiments of the present disclosure, the high-pass frequency divider 1304 may also be a multi-order frequency divider, and may be configured to perform multi-order frequency division processing on the audio driving signal from the main control circuit board 13, achieving a better low-frequency filtering effect and further alleviating the sound distortion phenomenon in the output of the second speaker 122 in low-frequency bands.

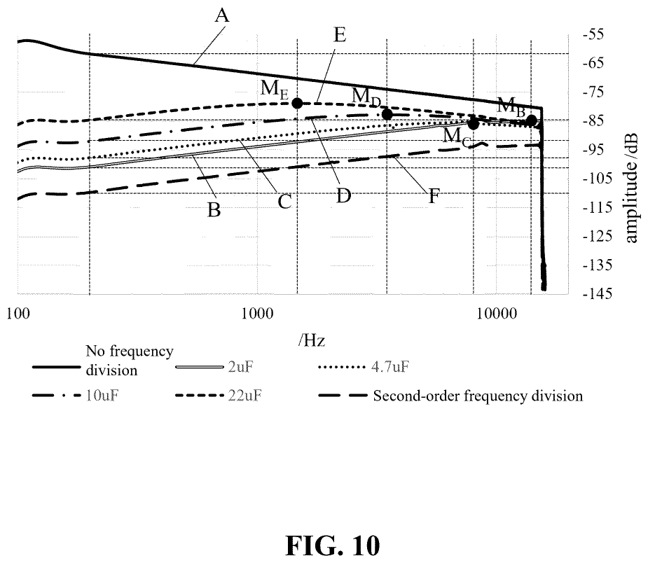

Referring to FIG. 10, FIG. 10 is a schematic diagram illustrating an exemplary frequency division effect of a second speaker 122 under different frequency division processing conditions when adjusting a high-pass frequency divider 1304 according to some embodiments of the present disclosure. Curve A represents an electrical signal curve received by the second speaker 122 when the high-pass frequency divider 1304 is not provided, i.e., the audio driving signal curve. Curves B, C, D, and E represent electrical signal curves received by the second speaker 122 after performing first-order frequency division using the high-pass frequency divider 1304. Corresponding to curve B, the capacitance of the frequency-dividing capacitor C of the high-pass frequency divider 1304 is 2 μF. Corresponding to curve C, the capacitance of the frequency-dividing capacitor C of the high-pass frequency divider 1304 is 4.6 μF. Corresponding to curve D, the capacitance of the frequency-dividing capacitor C of the high-pass frequency divider 1304 is 10 μF. Corresponding to curve E, the capacitance of the frequency-dividing capacitor C of the high-pass frequency divider 1304 is 22 μF. Curve F represents an electrical signal curve received by the second speaker 122 after performing second-order frequency division using the high-pass frequency divider 1304.

Referring to FIG. 10, near 200 Hz, a frequency response amplitude corresponding to curve A is approximately −62 dB, a frequency response amplitude corresponding to curve B is approximately −101 dB, a frequency response amplitude corresponding to curve C is approximately −98 dB, a frequency response amplitude corresponding to curve D is approximately −92 dB, and a frequency response amplitude corresponding to curve E is approximately −85 dB. That is, compared to curve A that represents the signal without the frequency division processing, the amplitude of signal components below 200 Hz in the electrical signal corresponding to curve B is attenuated by approximately 39 dB, the amplitude of signal components below 200 Hz in the electrical signal corresponding to curve C is attenuated by approximately 36 dB, the amplitude of signal components below 200 Hz in the electrical signal corresponding to curve D is attenuated by approximately 30 dB, and the amplitude of signal components below 200 Hz in the electrical signal corresponding to curve E is attenuated by approximately 23 dB. That is, compared to the audio driving signal without frequency division processing (corresponding to curve A), the amplitudes of signal components below 200 Hz in the electrical signals (corresponding to curves B, C, D, and E) after frequency division processing using a single capacitor element are all significantly attenuated. Thus, low-frequency components in the electrical signal received by the second speaker 122 are effectively suppressed, and the electrical signal after frequency division processing can effectively reduce the occurrence of the sound distortion phenomenon during sound output by the second speaker 122.

In some embodiments, the value of the capacitance of the frequency-dividing capacitor C may correspond to a theoretical frequency-dividing point:

$$C = \frac{1}{2 π fz} , \qquad ( 1 )$$

where f denotes a division frequency, z denotes a rated impedance of the second speaker 122, and C denotes a capacitance of the frequency-dividing capacitor C. It should be understood that when a count of frequency-dividing capacitors is a plurality, the capacitance C obtained through calculation by using formula (1) is an equivalent capacitance value of the plurality of frequency-dividing capacitors.

Due to a magnetic circuit system and a coil included in the structure of the second speaker 122, the coil acts as an inductor in a circuit, affecting the frequency-dividing point and causing a deviation between the actual frequency-dividing point and the theoretical frequency-dividing point. As shown in FIG. 10, an actual frequency-dividing point (i.e., a frequency corresponding to a maximum point Mb of the curve B) corresponding to the curve B is near 15 KHz. An actual frequency-dividing point (i.e., a frequency corresponding to a maximum point Mc of the curve C) corresponding to the curve C is near 8 kHz. An actual frequency-dividing point (i.e., a frequency corresponding to a maximum point Md of the curve D) corresponding to the curve D is near 3.4 kHz. An actual frequency-dividing point (i.e., a frequency corresponding to a maximum point Me of the curve E) corresponding to the curve E is near 1.5 kHz. Based on formula (1) and the curve C, the curve D, and the curve E, the actual frequency-dividing point is negatively correlated with the capacitance value of the frequency-dividing capacitor.

Referring to FIG. 10, an attenuation amplitude of the curve F in a higher frequency band (e.g., above 8 kHz) is also large. Correspondingly, an attenuation amplitude of a signal component in a higher frequency band of the electrical signal obtained through second-order frequency division processing is also large, affecting the normal output of the second speaker 122 in the higher frequency band. In addition, using two frequency-dividing capacitors leads to a more complex structure of the main control circuit board 13, thereby increasing manufacturing costs and the volume of the finally manufactured earphone 100. In summary, to simplify the circuit and reduce system complexity, and to ensure normal output of the second speaker 122 in a higher frequency band, the high-pass frequency divider 1304 may adopt the first-order frequency division. That is, the count of the frequency-dividing capacitors connected in series with the second speaker 122 may be one.

In some embodiments, if the count of the frequency-dividing capacitors connected in series with the second speaker 122 is one, to improve the frequency division effect and ensure normal output of the second speaker 122 in the higher frequency band, a range of the capacitance value of the frequency-dividing capacitor may be 4.2 μF-5.2 μF. In some embodiments, to further improve the frequency division effect and ensure normal output of the second speaker 122 in the higher frequency band, the range of the capacitance value of the frequency-dividing capacitor may be 4.4 μF-5.0 μF. In some embodiments, to further improve the frequency division effect and ensure normal output of the second speaker 122 in the higher frequency band, the range of the capacitance value of the frequency-dividing capacitor may be 4.5 μF-4.8 μF.

In some embodiments, the second rear cavity 1204 of the second speaker 122 is in a closed state and is not communicated with the outside. This causes an air pressure imbalance between the second front cavity 1203 and the second rear cavity 1204, which in turn causes a sound distortion phenomenon when the second speaker 122 outputs sound in the lower frequency band (e.g., below 200 Hz, such as 50-100 Hz).

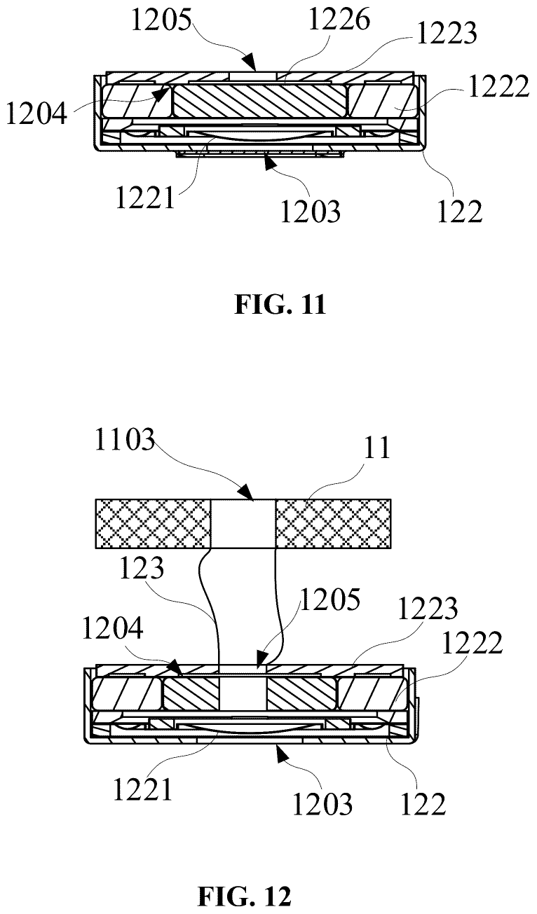

Referring to FIG. 11, FIG. 11 is a schematic diagram illustrating an exemplary structure of the second speaker 122 in FIG. 7 according to some other embodiments of the present disclosure. The speaker housing 1223 of the second speaker 122 is provided with a communication hole 1205 that communicates the second rear cavity 1204 with the outside of the second speaker 122. This alleviates the air pressure imbalance between the second front cavity 1203 and the second rear cavity 1204 caused by the closure of the second rear cavity 1204. Consequently, the sound distortion phenomenon when the second speaker 122 outputs sound in the lower frequency band (e.g., below 200 Hz, such as 50-100 Hz) due to the air pressure imbalance can be alleviated.

In some embodiments, the communication hole 1205 penetrates through the speaker housing 1223 to communicate with the second rear cavity 1204. For example, the communication hole 1205 may penetrate through a support frame of the speaker housing 1223 and communicate with the second rear cavity 1204. The support frame is located on a side of the speaker housing 1223 away from the second front cavity 1203. If the second speaker 122 is disposed in the first front cavity 1201 of the first speaker at this time, the communication hole 1205 may communicate the first front cavity 1201 with the second rear cavity 1204. Since the frequency range of sound output by the second speaker 122 is relatively high, and high-frequency sound waves have sharp directivity, when the first front cavity 1201 and the second rear cavity 1204 are communicated, sound waves radiated out from the second rear cavity 1204 through the communication hole 1205 rarely radiate toward the second front cavity 1203 again. Therefore, the provision of the communication hole 1205 does not affect the sound waves output by the first speaker 121. Thus, while alleviating the sound distortion phenomenon of the second speaker 122, the acoustic performance of the first speaker 121 is not affected.

In some embodiments, referring to FIG. 12, FIG. 12 is a schematic diagram illustrating an exemplary partial structure of the core module 10 in FIG. 11 according to some other embodiments of the present disclosure. The communication hole 1205 may also penetrate through the second magnetic circuit system 1222 and extend toward the second diaphragm 1221, so that the second magnetic circuit system 1222 surrounds the communication hole 1205, enabling the communication hole 1205 to communicate with the second rear cavity 1204. This more directly alleviates the air pressure imbalance between the second front cavity 1203 and the second rear cavity 1204, improves the function of the second rear cavity 1204, thereby alleviating the sound distortion phenomenon.

In some embodiments, an acoustic resistance at the communication hole 1205 may be in a range of 5×10⁸ Pa·s/m−1.3×10⁹ Pa·s/m. This avoids an increase in radiated sound pressure from the second rear cavity 1204 due to excessively small acoustic resistance, which would cause sound waves radiated from the first front cavity 1201 of the first speaker 121 to superimpose with sound waves radiated from the second rear cavity 1204 of the second speaker 122, resulting in extremely complex sound wave phases at an acoustic hole position and affecting listening effect. It also prevents the situation where, when the acoustic resistance is too large, the function of balancing the air pressure on the front and rear sides of the second diaphragm 1221 (i.e., the air pressure between the second front cavity 1203 and the second rear cavity 1204) cannot be achieved, failing to alleviate the sound distortion problem. In some embodiments, an acoustic resistance mesh 1226 may be disposed in the communication hole 1205 of the second speaker 122 to improve the acoustic resistance at the communication hole 1205 through the acoustic resistance mesh 1226, ensuring the sensitivity of the second speaker 122.

In some embodiments, an aperture range of the communication hole 1205 may be 0.8 mm to 1.2 mm, reducing an impact on air tightness if the communication hole 1205 is too small, and also reducing an impact on the sensitivity of the second speaker 122 if the communication hole 1205 is too large. In some scenarios, limiting the aperture of the communication hole 1205 can also reduce processing difficulty.

In some embodiments, in a radial direction of the second speaker 122 (e.g., the second diaphragm 1221), the communication hole 1205 may be centrally disposed relative to the second speaker 122 (e.g., the second diaphragm 1221). Here, the radial direction may be perpendicular to the axial direction of the second speaker 122, i.e., the radial direction is a direction perpendicular to a vibration direction of the second diaphragm 1221. The term “centrally disposed” means that, in the radial direction of the second speaker 122 (e.g., the second diaphragm 1221), a distance between an axis of the communication hole 1205 and an axis of the second speaker 122 (e.g., the second diaphragm 1221) is less than 10% of a length of the second speaker 122 (e.g., the second diaphragm 1221).

In some embodiments, the communication hole 1205 may not communicate the second rear cavity 1204 with the first front cavity 1201, but may directly communicate with an acoustic hole, such as the pressure relief hole 1103, provided on the core housing 11. High-frequency sound waves are radiated directly through the acoustic hole, such as the pressure relief hole 1103. This can further reduce the impact of sound waves radiated from the second rear cavity 1204 on sound waves radiated from the first front cavity 1201. In some embodiments, the aforementioned acoustic hole communicating with the communication hole 1205 may be a part of the first sound outlet hole 1101, or a part of the acoustic hole (e.g., the pressure relief hole 1103) communicating with the first rear cavity 1202, or an independent acoustic hole distinct from the other aforementioned acoustic holes. In this case, referring to FIG. 12, the communication hole 1205 may communicate with the aforementioned acoustic hole through a communication tube 123, to increase a sound path difference for transmission of sound waves radiated from the second rear cavity 1204, attenuate the radiated sound waves, and avoid sound leakage that may affect a user's auditory experience.

It should be understood that the provision of the communication hole 1205 can alleviate the sound distortion phenomenon existing when the second speaker 122 outputs sound in the low-frequency band (e.g., below 200 Hz, such as 50-100 Hz). Furthermore, the communication hole 1205 may cooperate with the high-pass frequency divider 1304 to alleviate the aforementioned sound distortion phenomenon. Certainly, the high-pass frequency divider 1304 may be omitted, and the aforementioned sound distortion phenomenon may be alleviated only through the communication hole 1205. In addition, when the communication hole 1205 and the high-pass frequency divider 1304 cooperate with each other, specific settings of the communication hole 1205 and the high-pass frequency divider 1304 may be adjusted according to specific situations.

Referring to FIG. 9, the driving circuit 132 may be disposed on the main control circuit board 13 to drive the speaker assembly 12 (e.g., the first speaker 121 and the second speaker 122). Furthermore, the driving circuit 132 may mainly include a DAC circuit 1321. Certainly, the driving circuit 132 may also include a power amplification circuit, a processor, etc. How to form the driving circuit 132 by using the DAC 1321 and other circuits is not described in detail herein.

The driving circuit 132 may be electrically connected to connection terminals, such as the first connection terminal 1301, the second connection terminal 1302, and other connection terminals, to achieve electrical connection with the speaker assembly 12 (e.g., the first speaker 121 and the second speaker 122), so as to drive the speaker assembly 12 (e.g., the first speaker 121 and the second speaker 122). That is, the low-pass frequency divider 1303, for example, the frequency division inductor L, may be disposed between the driving circuit 132 and the first speaker 121. The high-pass frequency divider 1304, for example, the capacitor C, may be disposed between the driving circuit 132 and the second speaker 122.

In some embodiments, the driving circuit 132 may drive both the first speaker 121 and the second speaker 122 simultaneously through only one DAC circuit 1321. That is, the driving circuit 132 may input the identical audio driving signals to the first speaker 121 and the second speaker 122.

It should be understood that the earphone 100 may further include electronic components that ensure normal operation of the earphone 100, such as a battery, a sensor, and an antenna. Such electronic components may be disposed in the core module 10 and/or the hook structure 20 as needed, and are not described in detail.

In the several embodiments provided in the present disclosure, it should be understood that the disclosed method and device may be implemented in other manners. For example, the device embodiments described above are merely illustrative. For example, the division of modules or units is merely a division based on logical functions. In actual implementation, there may be other division manners. For example, a plurality of units or components may be combined or integrated into another system, or some features may be omitted or not implemented.

Units described as separate components may or may not be physically separate. Components displayed as units may or may not be physical units. That is, they may be located in one place or may be distributed over a plurality of network units. Some or all of the units may be selected according to actual needs to achieve the objectives of the solutions of the embodiments.

In addition, functional units in the various embodiments of the present disclosure may be integrated into one processing unit, or each unit may exist alone physically, or two or more units may be integrated into one unit. The foregoing integrated unit may be implemented in the form of hardware or may be implemented in the form of a software functional unit.

The foregoing descriptions are merely specific embodiments of the present disclosure, but are not intended to limit the protection scope of the present disclosure. Any equivalent structure or equivalent process transformation made by using the content of the specification and drawings of the present disclosure, or any direct or indirect application thereof in other related technical fields, shall similarly fall within the protection scope of the present disclosure.

What is claimed is:

1. An earphone, comprising
a first speaker;
a second speaker;
a driving circuit configured to drive the first speaker and the second speaker, wherein at least a portion of a frequency band of sound output by the first speaker is lower than a frequency band of sound output by the second speaker; and
a high-pass frequency divider disposed between the driving circuit and the second speaker and configured to perform frequency division on an audio driving signal provided by the driving circuit to the second speaker, and a frequency-dividing point of the high-pass frequency divider is set to be not lower than 6 KHz.

2. The earphone according to claim 1, wherein the frequency-dividing point of the high-pass frequency divider is set to be not higher than 9 kHz.

3. The earphone according to claim 1, wherein the frequency-dividing point of the high-pass frequency divider is set to be not lower than 8 KHz.

4. The earphone according to claim 1, wherein the high-pass frequency divider is a one-order frequency divider consisting of a single capacitor.

5. The earphone according to claim 1, wherein a ratio of a resonant frequency of the second speaker to the frequency-dividing point is between 0.75 and 1.25.

6. The earphone according to claim 5, wherein the resonant frequency of the second speaker is equal to or greater than the frequency-dividing point.

7. The earphone according to claim 1, wherein the driving circuit is configured to simultaneously drive the first speaker and the second speaker via a same digital-to-analog conversion (DAC) circuit.

8. The earphone according to claim 5, wherein the audio driving signal of the driving circuit is configured to be directly input to the first speaker without undergoing frequency division processing.

9. The earphone according to claim 1, wherein a frequency-dividing point of the high-pass frequency divider is set such that a sound pressure level attenuation of sound output by the second speaker is not less than 20 dB.

10. The earphone according to claim 9, wherein the frequency-dividing point of the high-pass frequency divider is between 6 KHz and 9 kHz, and the sound pressure level attenuation of the sound output by the second speaker is not less than 30 dB.

11. The earphone according to claim 1, further comprising:
a low-pass frequency divider connected in series with the first speaker, and is between the driving circuit and the first speaker, and configured to perform frequency division on an audio driving signal provided by the driving circuit to the first speaker.

12. The earphone according to claim 11, wherein the low-pass frequency divider is a one-order frequency divider consisting of a single inductor.

13. The earphone according to claim 1, wherein the second speaker includes:
a second diaphragm for vibrating to generate sound,
a second magnetic circuit system for driving the second diaphragm to generate the sound, and
a speaker housing for carrying and mounting the second diaphragm and the second magnetic circuit system, a side of the second diaphragm facing away from the second magnetic circuit system forms a front cavity with a core housing for accommodating the first speaker and the second speaker, a side of the second diaphragm facing toward the second magnetic circuit system forms a rear cavity with the speaker housing, wherein the speaker housing is provided with a communication hole that communicates the rear cavity with an outside of the second speaker, and the communication hole penetrates through the second magnetic circuit system and extends toward the second diaphragm.

14. The earphone according to claim 13, wherein an acoustic resistance at the communication hole is in a range of 5×10⁸ Pa·s/m−1.3×10⁹ Pa·s/m.

15. The earphone according to claim 13, wherein an aperture range of the communication hole is 0.8 mm to 1.2 mm.

16. An earphone, comprising:
a first speaker;
a second speaker;
a driving circuit configured to drive the first speaker and the second speaker; and
a high-pass frequency divider disposed between the driving circuit and the second speaker, wherein a frequency-dividing point of the high-pass frequency divider is set such that a sound pressure level attenuation of sound output by the second speaker is not less than 20 dB.

17. The earphone according to claim 16, wherein a ratio of a resonant frequency of the second speaker to the frequency-dividing point is between 0.75 and 1.25.

18. The earphone according to claim 16, wherein the frequency-dividing point of the high-pass frequency divider is between 6 kHz and 9 kHz, and the sound pressure level attenuation of the sound output by the second speaker is not less than 30 dB.

19. The earphone according to claim 18, wherein the high-pass frequency divider performs first-order frequency division on an audio driving signal provided by the driving circuit to the second speaker.

20. The earphone according to claim 16, further comprising:
a low-pass frequency divider connected in series with the first speaker, and is between the driving circuit and the first speaker, and configured to perform frequency division on an audio driving signal provided by the driving circuit to the first speaker.
